(19) United States
(12) Patent Application Publication
(10) Pub. No.: US 2023/0303088 A1
(43) Pub. Date: Sep. 28, 2023

(54) DETERMINING A LOAD OF A DRIVE DEVICE

(71) Applicant: Siemens Aktiengesellschaft, 80333 München (DE)

(72) Inventors: CHRISTIAN DEEG, Altdorf (DE); MICHAEL LEIPOLD, Nürnberg (DE); MATTHIAS MANGER, Fürth (DE); BERND WACKER, Herzogenaurach (DE)

(73) Assignee: Siemens Aktiengesellschaft, 80333 München (DE)

(21) Appl. No.: 18/023,018

(22) PCT Filed: Aug. 10, 2021
(86) PCT No.: PCT/EP2021/072238

§ 371 Date: Feb. 24, 2023

(30) Foreign Application Priority Data
Aug. 25, 2020 (EP) 20192618.5

(51) Int. Cl. B60W 40/13

(52) U.S. Cl. CPC B60W 40/13

(57) ABSTRACT

A method and apparatus for determining a load of a drive device are disclosed. The drive device is provided with at least one sensor system which is coupled to a computing unit. By the sensor system, different data relating to the drive device in operation are detected. The detected data are transmitted to the computing unit and the detected data are compared to load-typical information stored in the computing unit. A type of load is determined based on the compared data.

The invention relates to a method for determining a load of a drive apparatus and to an apparatus for determining a load of a drive apparatus.

In principle, a drive task is allocated to a drive. The drive task is determined by a load. Often the drive task is designed empirically. For example a temperature is measured with the aid of temperature sensors, for example a coil temperature, or a vibration of a drive is measured with aid of vibration sensors. A lifetime of a coil system can be determined from the temperature measurement. Vibration sensors allow time series to be recorded and calculated, of amplitudes for example, and/or a calculation of frequency spectra, which in turn give information about a change. This allows deductions to be made about possible errors and possible wear. There are mathematical methods for calculating a rest of useful lifetime (RUL for short). These are based on temperature and mechanical variables, such as vibrations for example.

Methods are known from the prior art for determining a load moment characteristic curve. For example a start-up behavior of a drive is determined through a torque developed by a motor and counter torques of a machine to be driven. For example different load moments or the same load moments or characteristic curves are strung together cyclically or acyclically over time.

It is known for example that load patterns can be recognized with the aid of a measured electric current. These enable the torque to be deduced and also make it possible to measure a retroactive effect of the mechanical load on the current, for example for determining a harmonic or a ripple content on the current phases or periodically recurring or pulsing patterns on the course of the phase current. A current can be measured via current converters or via small signal converters. However it is not always possible to measure the current since an accessibility for electrical converters is needed. This requires both an electrical and also mechanical access, for example via cable, installation space, switch boxes and/or terminal boxes.

The underlying object of the invention is to specify an improved method for determining a load and an improved apparatus for determining a load of a drive apparatus compared to the prior art.

In respect of the method the object is achieved in accordance with the invention by the features specified in claim 1. In respect of the apparatus the object is achieved in accordance with the invention by the features specified in claim 8.

Advantageous embodiments of the invention are the subject matter of the subclaims.

Within the framework of the present disclosure the term “load” is understood as a facility/apparatus that is driven during operation of the drive apparatus. In particular this facility/apparatus involves a working machine, preferably a working machine of an automation system. The working machine can be embodied for example as a pump, a motor-driven valve, a fan, a winch, a conveyer belt etc.

In this context the terms “mechanical load”, “electrical load” etc. related to the drive apparatus are to be understood as an effect of the load on the corresponding (mechanical, electrical etc.) behavior of the drive apparatus that drives the load—i.e. a corresponding capacity utilization.

In a method for determining a load of a drive apparatus the load is connected to the drive apparatus, wherein the drive apparatus is provided with at least one sensor system, in particular a local system, with said sensor system being coupled to at least one computing unit wherein, by means of the sensor system, different data relating to the drive apparatus in operation (or the operation of the drive apparatus) is preferably detected. The data detected is transmitted to the computing unit, wherein the data detected is compared with information typical of the load that is characteristic for a type of the load stored in the computing unit. A type of load is subsequently determined with the aid of the compared data.

If the type of load has been established, the drive apparatus can be operated according to the load type established. Thus a method for operating a drive apparatus is also disclosed.

The term “information typical of a load” is to be understood as any information that is characteristic of the type of load (in operation of the automation system) connected to the drive apparatus or which describes said information. In other words the information typical of a load contains relationships between drive apparatuses (drives) and loads, for example in the form of (already known) drive-load configurations.

The “type” of the load is understood within the framework of the present disclosure as types of working machines. For example a pump, a motor-driven valve, a fan, a winch, a conveyor etc. Involve a load of type “pump”, “valve”, “fan”, “winch”, “conveyor belt” etc.

The sensor system is thus used in order, during operation, to establish the drive apparatus and preferably additionally data relating to the load and finally to recognize the type of the load or to make a deduction about the load and thus about the drive task. For example the type of drive is established for which the load is to be applied. Determining the type of the load enables a mechanical and/or electrical loading of the drive apparatus to be deduced. The type of the load is for example determined “offline” via an external database, in which statistical comparisons and mathematical calculations take place. The computing unit is a Cloud and/or a server for example. The computing unit for example comprises at least one database in which in the information typical of the load, which for example contains the already known drive load configurations, is stored. The database thus comprises a corresponding historical knowledge that can be accessed for determining the type of the load. The computing unit can access this information at any time.

In one form of embodiment there is provision for the load also to be provided with the sensor system.

The drive apparatus is used for example in conveyor systems, for example for driving pumps, compressors, fans, machine tools (different load types) and in other industrial applications.

By means of the method it is possible in an especially advantageous way, from the information established about the type of load, to establish a service life both of individual components of the drive apparatus and also of the drive apparatus itself.

In many cases the purpose and the load for which the drive apparatus will be employed are not known. The drive apparatus is for example a pneumatic drive, a hydraulic drive or an electric drive. An electric drive can for example be an electric motor or an electric drive with an electric motor that is driven by a variable speed converter. Conventionally, universal motors or standard motors are ordered from catalogs. The drive task does not have to be available at the time that the drive is ordered. The drive task or the load determines a mechanical and electrical loading of the drive apparatus. The electrical current is often not accessible as a measurement variable, since the measurement is made in a switching system. Without specifications as to the purpose or the load of the drive apparatus it is not possible to determine its lifetime. The load can influence wear, for example mechanical wear, on bearings and bearings and bearing shields of the drive apparatus. The electrical current used during operation with a torque leads to thermal heating, which in its turn leads to an ageing of a coil in stators or rotors.

One embodiment of the invention makes provision, with the aid of the information established about load type, to determine the lifetime of the drive apparatus. The determination of the lifetime gives a hint about the technical and economic utilization and also about the period of use during which the drive can sensibly be operated. Thus a lifetime and an RUL (Rest of Useful Lifetime) are determined with the aid of information that can be established about the load.

In one development the information about the type of the load is used in order to establish setting parameters of an electrical drive apparatus for example. Conventionally the setting parameters of the electrical drive apparatus are already pre-specified at the time of a commissioning or putting into operation of the drive apparatus. As a rule setting parameters about the start-up curve, braking curve and the like are set once and no longer optimized thereafter. Depending on the Information about the type of the load, the setting parameters are able to be established and output at any time so the drive apparatus can be adjusted to increase Its lifetime.

In many cases no information is available to an expert about the load. The load can however likewise have a so-called RUL. If a pump of which the pump wheel is wearing mechanically is connected to an electric motor for example. This wear is able to be recognized predictively from an increasing load and/or from an increasing vibration parameter. Thus a difficulty exists of making a clear diagnosis in respect of a correct differentiation of wear conditions, from faults or wear-dependent wear and tear in components of the drive apparatus or in the driven load.

In a further form of embodiment the sensor system is coupled to at least one data processing unit, by means of which the data detected is processed and transmitted to the computing unit. For example the drive apparatus is retroactively provided or equipped with the data processing unit. As an alternative the data processing unit can already be part of the drive apparatus. As an alternative the data processing unit can be part of the sensor system. The drive apparatus can for example be equipped retroactively with the sensor system and also with the data processing unit. For example the data processing unit is a so-called edge device.

In a further form of embodiment data from at least one temperature measurement, vibration measurement, airborne sound measurement, rotating field measurement, slippage measurement and/or current measurement can be detected by means of the sensor system. The data detected by means of the sensor system is transferred to the data processing unit, which subsequently evaluates the data at the drive apparatus for example locally, and analyzes or preprocesses it without any delay.

In a further form of embodiment the data detected is analyzed and a time sequence of the data and/or a continuous series of measurements established. The analysis of the data detected and establishment of the time sequence and/or the series of measurements are or is carried out by the data processing unit. Subsequently this data is transferred to the computing unit. For example changes and/or deviations of the load over a period of time are established and monitored. For example time series of the data established are included for statistical comparisons and mathematical calculations. Thereby it is made possible to make diagnoses about errors and the remaining lifetime and also to make diagnoses about setting parameters. With the aid of the diagnoses setting parameters for correcting the errors and increasing the remaining lifetime of the drive apparatus are established and suggested. In an automated environment the established and suggested setting parameters are transmitted directly to the controller of the drive apparatus and implemented by the latter. This means that an operation intervention at the controller can take place automatically. As an alternative or in addition a suggestion for changing the setting parameters and reparameterization of the drive apparatus is output. In this way a user can be shown so-called Key Performance Indicators (abbreviated to KPIs) and potential optimizations in respect of the operation of the drive apparatus. In one development dynamic and operative warning limits are set.

For example an engineering expert who is designing the drive can gain experience by considering the analysis of the information about the load, in order to design a drive task in a more optimum way in the future by selecting the motors and/or converter. Furthermore a development engineer, from a plurality of feedback from actual operation, can optimize a drive train or a drive system (motor/transmission/converter/load) in respect of design and construction. This enables processing times to be shortened and time-to-market for new types to be improved.

In a further form of embodiment data from previous measurements at the same drive apparatus is stored as information typical of the load. This means that the information typical of the load stored in the computing unit, in particular in the database, based on data that has been established from a number of measurements at the same drive apparatus. For example the newly detected data and time series are compared with data of the same drive apparatus already obtained earlier, in particular compared statistically.

In a further form of embodiment data from previous measurements at different drive apparatuses is stored as information typical of the load. This means that the information typical of the load stored in the computing unit, in particular in the database, is based on data that was established from a number of measurements of different drive apparatuses. For example the newly detected data and time series are compared with data of other drive apparatuses already obtained earlier, in particular compared statistically.

In a further form of embodiment, with the aid of information about the type of the load, at least one simulation of the drive apparatus is carried out for evaluation of a usage model to accompany operation and/or of a predictive usage model. In particular accompanying and predictive simulations of a real drive with a real load are carried out. Depending on results of the simulation an operative intervention is carried out at the controller and/or a suggestion for setting dynamic and operative warning limits is output and/or a suggestion for a reparameterization of the drive apparatus is output. With the aid of newly established and/or newly set parameterizing data a rest of useful lifetime of the drive apparatus is calculated and output. In one development algorithms for what is known as machine learning and reinforcement learning are applied.

In order to avoid the drive apparatus being able to be manipulated in respect of a reparameterization, a bidirectional communication channel, for example a virtual private network (VPN), is used for example. The automatic reparameterization of the drive apparatus is made visually recognizable for example, so that a shift leader (operator) can see changes and also cancel them or make them blockable.

Furthermore the invention relates to an apparatus for determining a load of a drive apparatus, wherein the apparatus comprises at least one sensor system able to be coupled to a drive apparatus and a computing unit coupled or able to be coupled to the sensor system. The computing unit is in particular a decentralized computing unit. The sensor system is configured to detect data relating to the drive apparatus in operation and to transmit the data detected to the computing unit. Load-typical information is stored in the computing unit or in a database coupled to the computing unit, wherein the computing unit is configured to compare the data detected with the stored information typical of the load and to determine a type of the load with the aid of the compared data.

The database can for example be a component of a computing unit, in particular of a decentralized computing unit. The computing unit is for example a server and/or a Cloud. The database in this case is thus implemented decentrally.

In a further form of embodiment the sensor system comprises a number of sensors for temperature measurement and/or vibration measurement and/or airborne sound measurement and/or rotating field measurement and/or slippage measurement and/or current measurement.

In a further form of embodiment the apparatus comprises at least one data processing unit, which is coupled to the sensor system, wherein the data processing unit is configured to receive the data detected by means of the sensor system and to process it locally and transmit it to the computing unit. The data processing unit is for example a local data processing unit, in particular what is known as an edge device. The data processing unit comprises a processor for example, a working memory and/or program memory and also interfaces that make communication with the environment possible. The data processing unit is for example arranged locally in an environment of the drive apparatus. The data processing unit is further embodied to store and change parameter settings of the drive apparatus. The data processing unit Is coupled or is able to be coupled at least via a bidirectional communication channel to the computing unit. Through this an ability of the drive apparatus to be able to be manipulated from outside in respect of a reparameterization of the drive apparatus is avoided. For example the computing unit is configured, with aid of the information established about the type of the load, to establish setting parameters to transfer these to the data processing unit. The data processing unit is coupled for example to an open-loop and/or closed-loop control unit of the drive apparatus. The open-loop and/or closed-loop control unit is accessible for a user of the drive apparatus, who can set the reparameterization of the drive apparatus with the aid of the setting parameters transferred. In addition or as an alternative the data processing unit is configured to undertake the reparameterization of the drive apparatus automatically.

The computing unit is for example coupled or able to be coupled to a plurality of data processing units of other environments and industrial applications.

The sensor system is not linked either to switchgear, for example what is known as a Motor Control Center (abbreviated to MCC), of the drive apparatus or to the automation system of a sort or drive. The sensor system has no influence on an operation of the drive apparatus.

The sensor system is coupled for example to the drive apparatus in the area of a motor, a valve facility, a working machine and/or a bearing. For example the sensor system is able to be arranged in any area of the drive apparatus that is subjected to temperatures and/or vibrations and/or in which an airborne sound measurement, rotating field measurement, slippage measurement and/or a current measurement is able to be carried out. For example the sensor system comprises pressure sensors, temperature sensors, vibration sensors, oscillation sensors, magnetic field sensors, sound sensors, acceleration sensors, current sensors and/or other magnetic, inductive and/or optical sensors.

In a further form of embodiment the sensor system is coupled to the data processing unit and the data processing unit is coupled to the computing unit via wireless and/or wired connection. For example the respective communication takes place via what is known as a LAN, VPN, DSL and/or radio connection.

In summary the Inventive method and the inventive apparatus make it possible to establish a type of a load connected to a drive (to a drive apparatus), for example an unknown load on the basis of sensor-based data. In this case the sensor data is compared with typical patterns (already known relationships between drive apparatuses and loads).

If the type of the load has been established, the drive apparatus can be operated according to the load type established. For example, the drive apparatus can be operated in accordance with a working plan (loading, maintenance, etc.), which Is determined with the aid of the load type established. Moreover maintenance of the drive apparatus can mean in intervals that are related to the type of the load to which the drive apparatus is connected.

The characteristics, features and advantages of this Invention described above as well as the manner in which these are achieved, will become clearer and easier and to understand in conjunction with the description of exemplary embodiments given below, which is explained in greater detail in conjunction with the drawings, in which:

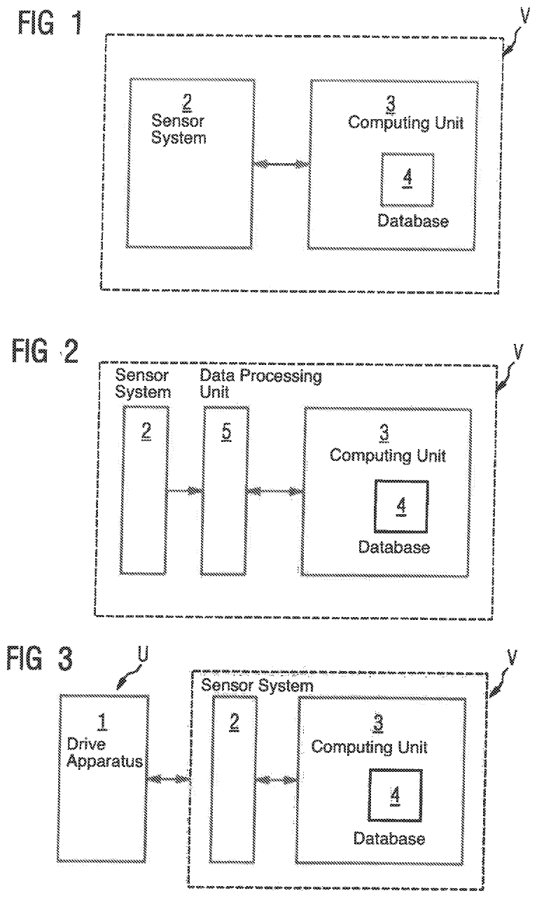

FIG. 1 shows schematically a form of embodiment of an apparatus for determining a load of a drive apparatus,

FIG. 2 shows schematically a further form of embodiment of an apparatus for determining a load of a drive apparatus,

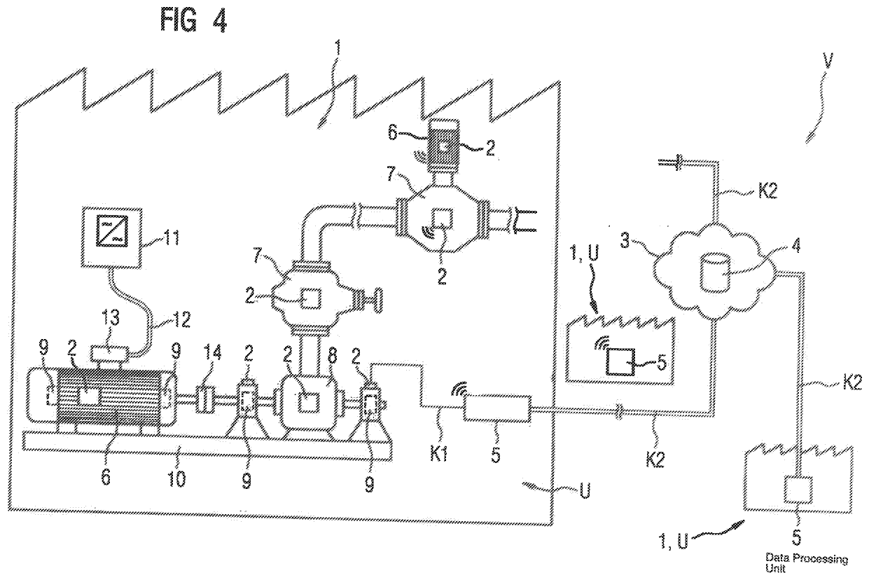

FIG. 3 shows schematically a form of embodiment of a drive apparatus, which is coupled to the apparatus for determining a load, and

FIG. 4 shows schematically a further form of embodiment of a drive apparatus, which is coupled to the apparatus for determining a load.

Parts corresponding to one are provided with the same reference characters in the figures.

FIG. 1 shows schematically a form of embodiment of an apparatus V for determining a load of a drive apparatus 1 shown schematically in FIG. 3 or FIG. 4.

The apparatus V comprises a sensor system 2 able to be coupled to the drive apparatus 1. Furthermore the apparatus V comprises a computing unit 3 coupled by wire or wirelessly to the sensor system 2. The computing unit 3 is in particular a decentralized computing unit 3, such as for example a server facility. The sensor system 2 is configured to detect data relating to the drive apparatus 1 in operation and to transmit the data detected to the computing unit 3. Load-typical information is stored in the computing unit 3. For example the computing unit 3 comprises at least one database 4, in which information typical of the load is stored. The computing unit 3 is configured to compare the data detected with the stored load-typical information and, with the aid of the compared data, to determine a type of the load n. For example the load Is assigned a drive task. Through this a type of the drive apparatus is determined. Through this information a lifetime and/or rest of useful lifetime of the drive apparatus and its technical and economic benefit and the duration of its use can be established. For example the type of the load is assigned a kind of drive apparatus and it is established whether what is involved here for example is a pneumatically, hydraulically or electrically driven drive.

Data from previous measurements at the same drive apparatus 1 is stored as Information typical of the load. This means that the information typical of the load stored in the computing unit 3, in particular in the database 4, is based on data that has already been established from a number of measurements at the same drive apparatus 1. For example the newly detected data and time series are compared with data of the same drive apparatus 1 already obtained earlier, in particular compared statistically.

Furthermore data from previous measurements at different drive apparatuses 1 is stored in addition as information typical of the load. This means that the Information typical of the load stored in the computing unit 3, in particular in the database 4, is based on data that has been established from a number of measurements of different drive apparatuses 1. For example the newly detected data and time series are compared with data of other drive apparatuses 1 already obtained earlier, in particular compared statistically.

The sensor system 2 comprises a number of sensors for temperature measurement and/or vibration measurement and/or airborne sound measurement and/or rotating field measurement and/or slippage measurement and/or current measurement.

FIG. 2 shows schematically a further form of embodiment of an apparatus V for determining a load of a drive apparatus 1 shown schematically in FIG. 3 and FIG. 4.

In the further form of embodiment the apparatus V comprises a data processing unit 5, which Is coupled to the sensor system 2. The data processing unit 5 is configured to receive the data detected by means of the sensor system 2 and to process it locally. For example the data detected by the sensor system 2 is analyzed and a temporal order of the data and/or a continuous series of measurements is established. The analysis of the data detected and establishment of the temporal order and/or the series of measurements is carried out by the data processing unit 5. In one development the sensor system 2 comprises the data processing unit 5. The sensor system 2 is then for example configured to use the data detected of its sensors for further data processing. Subsequently this data is transferred to the computing unit 3. For example changes and/or deviations of the load over a period of time are established and monitored in the computing unit 3. For example time series of the data established are employed for statistical comparisons and mathematical calculations. Through this it is made possible to make diagnoses for errors and for the rest of useful life and also for setting parameters. With aid of the diagnoses setting parameters for correcting the errors and for increasing the rest of useful life of the drive apparatus 1 are established and suggested. In an automated environment U of the drive apparatus 1 (as shown schematically in FIG. 2) the established and suggested setting parameters can be transmitted to the controller of the drive apparatus 1 and implemented by said device. This means that an operative intervention at the controller can be undertaken automatically. As an alternative or in addition a suggestion for changing the setting parameters and reparametrizing the drive apparatus 1 is output for example via a display apparatus, such as s screen. In this way a user can be shown so-called Key Performance Indicators (abbreviated to KPIs) and potential optimizations in respect of the operation of the drive apparatus 1. The reparameterization is carried out manually as required by the user of the drive apparatus 1. In one development dynamic and operative warning limits are set.

The data processing unit 5 is furthermore configured to transmit the data detected by means of the sensor system 2 to the computing unit 3. The data processing unit 5 is for example a local data processing unit 5, in particular a so-called edge device and/or edge computer. The data processing unit 5 for example comprises a processor, a working memory and/or program memory as well as communication interfaces that make communication with the environment U possible. The data processing unit 5 is for example arranged locally in the environment U of the drive apparatus 1. The data processing unit 5 is further embodied to store and to change parameter settings of the drive apparatus 1. The data processing unit 5 is coupled via at least one bidirectional communication channel to the computing unit 3. Through this an ability of the drive apparatus 1 to be manipulated from outside in respect of a reparameterization of the drive apparatus 1 is avoided. For example the computing unit 3 is configured, with the aid of the information established about the type of the load, to establish suitable setting parameters and to transmit these to the data processing unit 5 and/or to an open-loop and/or closed loop control unit of the drive apparatus 1. The data processing unit 5 is for example coupled to an open-loop and/or closed loop control unit of the drive apparatus 1. The open-loop and/or closed loop control unit is accessible to a user of the drive apparatus 1, who, with the aid of the setting parameters transferred, can set and/or inspect the reparameterization of the drive apparatus 1. In addition or as an alternative the data processing unit 5 is configured to undertake the reparameterization of the drive apparatus 1 automatically.

For example the sensor system 2 is coupled to the data processing unit 5 and the data processing unit 5 is coupled to the computing unit 3 via a wireless and/or wired connection. For example the respective communication takes place via a so-called LAN, VPN, DSL and/or radio connection.

FIG. 3 shows schematically a form of embodiment of a drive apparatus 1, which Is coupled to the apparatus V for determining a load of the drive apparatus 1. The drive apparatus 1 is employed for example in conveyor systems, pumps, compressors, fans, machine tools and in other industrial applications.

The sensor system 2 is not linked to either switchgear, for example to a so-called Motor Control Center (abbreviated to MCC), of the drive apparatus 1 or to an automation system of the environment U. The sensor system 2 thus has no Influence on an operation of the drive apparatus 1.

The sensor system 2 is for example coupled to the drive apparatus 1 in the area of a motor 6, a valve facility 7, a working machine 8 and/or a bearing 9, as shown in FIG. 3. For example sensors of the sensor system 2 are able to be arranged in any area of the drive apparatus 1 that is subjected to temperatures and/or vibrations and/or in which an airborne sound measurement, rotating field measurement, slippage measurement and/or a current measurement is able to be carried out. For example the sensor system 2 comprises pressure sensors, temperature sensors, vibration sensors, oscillation sensors, magnetic field sensors, sound sensors, acceleration sensors, current sensors and/or other magnetic, inductive and/or optical sensors.

FIG. 4 shows schematically a further form of embodiment of a drive apparatus 1 that is coupled to an apparatus V for determining a load of the drive apparatus 1.

The drive apparatus 1 comprises for example a plurality of components acting on one another, which at least in part are arranged on a base frame 10. For example the drive apparatus 1 comprise a first motor 6, which is connected to a converter 11 via a cable arrangement 12. For this the motor 6 has an interface 13, for example in the form of a terminal or a junction box. The motor 6 is provided on both sides with a bearing 9. Furthermore the motor 6 is provided with a sensor system 2 or with a number of sensors. Via one of the bearings 9 the motor 6 is connected to a clutch 14, which in its turn Is connected to a further bearing 9 and subsequently to a working machine 8, for example a pump. The working machine 8 is for example provided with the sensor system 2 or with a number of sensors. The working machine 8 is connected for example with two bearings 9. These bearings 9 are likewise provided with a sensor system 2 or with sensors of the sensor system 2. Furthermore the working machine 8 is coupled via a tube arrangement to a plurality of valve facilities 7. For example one of the valve facilities 7 is coupled to a further motor 6. Both the further motor 6 and also the valve facilities 7 are provided with a sensor system 2 or sensors of the sensor system 2. The sensor system 2 of the sensors of the sensor system 2 are each configured to detect data from at least one temperature measurement, vibration measurement, airborne sound measurement, rotating field measurement, slippage measurement and/or current measurement.

The respective sensors of the sensor system 2 are for example coupled via a communication connection K1, such as a LAN connection and/or wireless radio connections, to the data processing unit 5. The data processing unit 5 receives the data detected by means of the sensors and processes this locally.

The data processing unit 5 is for example coupled via a further communication connection K2, for example a remote network connection such as a VPN or DSL connection, to the computing unit 3. The computing unit 3, in the example shown, is represented as a Cloud. The computing unit 3 comprises the database 4, on which information typical of the load is stored. The computing unit 3 is configured to compare the new data transferred from the data processing unit 5 with the stored information typical of the load and make a deduction about the type of the load.

The computing unit 3 is coupled for example to plurality of data processing units 5 of other drive apparatuses 1 in other environments U. This enables a mass of information, for example Information typical of the load, from a plurality of the same and/or different drive apparatuses 1 and environments U to be collected and processed.

Although the invention has been Illustrated and described in greater detail by preferred exemplary embodiments, the invention Is not restricted by the disclosed examples and other variations can be derived herefrom by the person skilled in the art without departing from the scope of protection of the invention.

1.-13. (canceled)

14. A method for operating a drive apparatus, the method comprising:
connecting a load, i.e. a working machine of an automation system, to the drive apparatus;
coupling a sensor system of the drive apparatus to a computing unit;
detecting data relating to the drive apparatus in operation with the sensor system;
transmitting the detected data to the computing unit;
comparing the detected data with information typical of the load that is characteristic for a type of the working machine stored in the computing unit in order to establish the type of the working machine; and
operating the drive apparatus according to the established type of the load.

15. (canceled)

16. The method of claim 14, further comprising:
coupling the sensor system to a data processing unit;
processing the detected data locally with the data processing unit; and
transmitting the processed data with the data processing unit to a database of the computing unit.

17. The method of claim 14, further comprising detecting with the sensor system data from at least one member selected from the group consisting of temperature measurement, vibration measurement, airborne sound measurement, rotating field measurement, slippage measurement and current measurement.

18. The method of claim 14, further comprising:
analyzing the detected data; and
establishing a temporal order of the detected data and/or a continuous series of measurements.

19. The method of claim 14, further comprising storing data from previous measurements at the same drive apparatus as information typical of the load.

20. The method of claim 14, further comprising storing data from previous measurements at different drive apparatuses as information typical of the load.

21. The method of claim 14, further comprising carrying out a simulation of the drive apparatus, with information about the type of the load, for evaluation of a usage model accompanying operation and/or of a predictive usage model.

22. The method of claim 14, further comprising providing the load with the sensor system.

23. Apparatus for operating a drive apparatus, the apparatus comprising:
a load, i.e. a working machine of an automation system, connected to the drive apparatus;
a sensor system coupled to the drive apparatus and configured to detect data relating to the drive apparatus in operation and to transmit the detected data; and
a computing unit with Information typical of the load stored in the computing unit coupled to the sensor system and receiving the detected data transmitted from the sensor system, said computing unit configured to
compare the detected data with information typical of the load characteristic for a type of the working machine stored in the computing unit,
determine with aid of the compared data a type of the working machine, and
operate the drive apparatus according to the established type of the load.

24. (canceled)

25. The apparatus of claim 23, wherein the sensor system comprises a number of sensors for temperature measurement, vibration measurement, airborne sound measurement, rotating field measurement, slippage measurement and/or current measurement.

26. The apparatus of claim 23, further comprising a data processing unit coupled to the sensor system and configured to receive the data detected the sensor system, to process the detected data locally, and to transmit the processed data to the computing unit.

27. The apparatus of claim 23, wherein the sensor system is coupled to the load and configured to detect data relating to the operation of the load.

28. The apparatus of claim 23, wherein the working machine is embodied as a pump, a motor-driven valve, a fan, a winch, or a conveyer belt.
